(19) United States
(12) Patent Application Publication
(10) Pub. No.: US 2010/0328474 A1
(43) Pub. Date: Dec. 30, 2010

(54) WIRELESS REMOTE CONTROL SYSTEM AND METHOD FOR CAMERAS

(75) Inventor: MING-CHIH HSIEH, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/547,451

(22) Filed: Aug. 25, 2009

(30) Foreign Application Priority Data
Jun. 25, 2009 (CN) 200910303616.5

(51) Int. Cl. H04N 5/232

(52) U.S. Cl. 348/211.2; 348/211.4; 348/E05.042

(57) ABSTRACT

A remote control system is used to control a plurality of cameras. The remote control system includes a frequency identification (RFID) reader and a plurality of RFID tags. Each tag has a unique code and is embedded in a corresponding camera. Each tag stores information of the corresponding camera. The RFID reader reads the information in the tag to control the corresponding camera.

### BACKGROUND

1. Technical Field

The present disclosure relates to control systems and methods, and particularly to a wireless remote control system and a method for use with cameras.

2. Description of Related Art

A network camera can be used for a video meeting via remote control. The network camera is remotely controlled to be turned on, turned off, or change lens angles by a terminal computer. When there are many people speaking in the video meeting, the lens angles of the network camera should be adjusted frequently, thereby to make video records of speakers.

However, the terminal computer is usually placed in a computer room other than the meeting room, and the terminal computer is connected with the network camera via cables. Therefore, it is inconvenient for an operator to control the network camera, and the cables connected between the network camera and the terminal computer may interfere with adjusting the camera.

### BRIEF DESCRIPTION OF THE DRAWINGS

FIG. 1 is a block diagram of an exemplary embodiment of a wireless remote control system for cameras.

FIG. 2 is a sketch view of an exemplary embodiment of the wireless remote control system of FIG. 1 used to control cameras.

FIG. 3 is a flowchart of an exemplary embodiment of a wireless remote control method for cameras.

### DETAILED DESCRIPTION

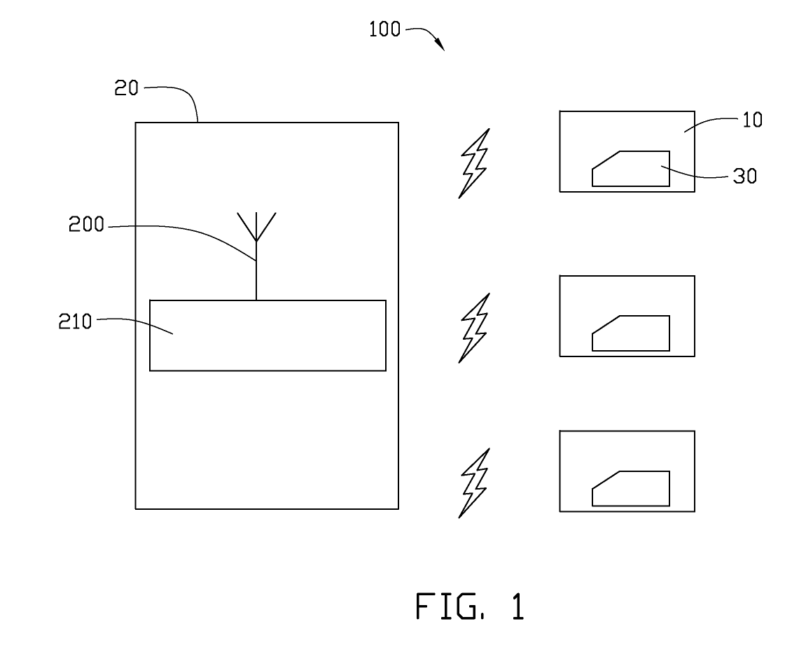

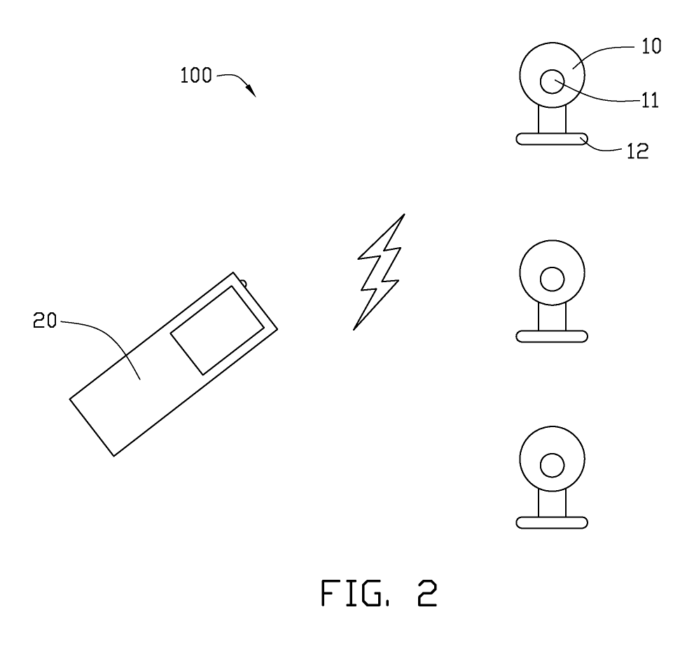

Referring to FIG. 1 and FIG. 2, an exemplary embodiment of a wireless remote control system 100 is used to control a plurality of cameras 10 via radio frequency identification (RFID) technology. Each of the plurality of cameras 10 includes a lens 11 and an adjustable base 12. The wireless remote control system 100 includes an RFID reader 20 and a plurality of RFID tags 30.

Each of the RFID tags 30 is formed on a corresponding camera 10 and includes a unique code used to label the corresponding camera 10 and store information of the corresponding camera 10, such as a serial number. The RFID tags 30 include coupling components.

The RFID reader 20 includes an antenna 200 and a wireless transceiver system 210. The RFID reader 20 may be portable or fixed. In one exemplary embodiment, the RFID reader 20 is a portable remote controller.

The antenna 200 transmits and receives radio frequency signals between the RFID tag 30 and the wireless transceiver system 210. The wireless transceiver system 210 includes a plurality of list files to read or write the information of the camera 10 of the corresponding RFID tag 30. In use, the wireless transceiver system 210 sends a selection command via the antenna 200 to the RFID tag 30 to select a corresponding camera 10, and then transmits an operation command to operate the camera 10, for example, to adjust the adjustable base 12 to modify the lens angle of the camera 10, or to draw forward or draw back the lens 11 to modify a depth of field of the camera 10.

The wireless transceiver system 210 also has an add option to add a new camera 10 to the wireless remote control system 100 and a delete option to delete an old camera 10 from the wireless remote control system 100. When the new camera 10 is added to the wireless control system 100, the wireless transceiver system 210 writes information of the new camera 10 to a corresponding RFID tag 30 to add the new camera 10. When the old camera 10 is deleted from the wireless control system 100, the wireless transceiver system 210 deletes information of the old camera 10 stored in a corresponding RFID tag 30. Therefore, the wireless remote control system 100 controls the plurality of cameras 10 without using cables.

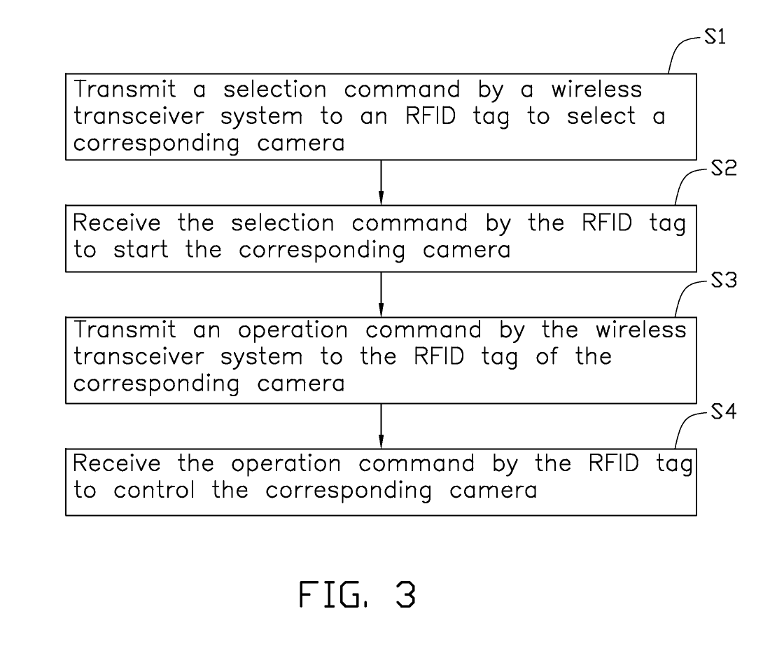

Referring to FIG. 3, a wireless remote control method for the plurality of cameras 10 is provided, which includes the following steps.

In step S1, the wireless transceiver system 210 transmits a selection command via the antenna 200 to a frequency identification (RFID) tag 30 to select a corresponding camera 10.

In step S2, the RFID tag 30 of the corresponding camera 10 is activated when the RFID tag 30 receives the selection command, and the corresponding camera 10 is activated.

In step S3, the wireless transceiver system 210 transmits an operation command via the antenna 200 to the RFID tag 30 of the corresponding camera 10.

In step S4, the RFID tag 30 receives the operation command to control the corresponding camera 10, such as to adjust the adjustable base 12 of the camera 10 to modify the lens angle of the camera 10, to draw forward or draw back the lens 11 of the camera 10 to modify a depth of field of the camera 10, and so on.

It is to be understood, however, that even though numerous characteristics and advantages of the present disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. A wireless remote control system for controlling a plurality of cameras, comprising:
a plurality of radio frequency identification (RFID) tags, each of the RFID tags with a unique code formed on a corresponding camera and storing information of the corresponding camera; and
an RFID reader to read the information of the plurality of RFID tags, and control the corresponding camera via the corresponding RFID tag.

2. The system of claim 1, wherein the RFID reader comprises an antenna and a wireless transceiver system; wherein the wireless transceiver system reads the information in the RFID tag via the antenna to control the corresponding camera.

3. The system of claim 1, wherein the RFID reader comprises an add option to add a new camera to the wireless remote control system.

4. The system of claim 1, wherein the RFID reader comprises a delete option to delete a camera from the wireless remote control system.

5. A wireless remote control method for a plurality of cameras, comprising:
transmitting a selection command by a wireless transceiver system to an frequency identification (RFID) tag to select a corresponding camera;
receiving the selection command by the RFID tag to activate the corresponding camera;
transmitting an operation command by the wireless transceiver system to the RFID tag of the corresponding camera; and
receiving the operation command by the RFID tag to control the corresponding camera.

6. The method of claim 5, wherein the RFID reader comprises an antenna and a wireless transceiver system; wherein the wireless transceiver system reads the information in the RFID tag via the antenna to control the corresponding camera.

7. The method of claim 5, wherein the RFID reader comprises an add option to add a new camera to the wireless remote control system.

8. The method of claim 5, wherein the RFID reader comprises a delete option to delete a camera from the wireless remote control system.

9. A wireless remote control system for controlling at least one camera, comprising:
at least one radio frequency identification (RFID) tag, each of the at least one RFID tag with a unique code formed on a corresponding one of the at least one camera and storing information of the corresponding camera; and
an RFID reader to read the information of each of the at least one RFID tag, and to control the corresponding camera via the corresponding RFID tag.

10. The system of claim 9, wherein the RFID reader comprises an antenna and a wireless transceiver system; wherein the wireless transceiver system reads the information in the at least one RFID tag via the antenna to control the corresponding camera.

11. The system of claim 9, wherein the RFID reader comprises an add option to add a new camera to the wireless remote control system.

12. The system of claim 9, wherein the RFID reader comprises a delete option to delete a camera from the wireless remote control system.
